(19) United States
(12) Patent Application Publication
(10) Pub. No.: US 2025/0175929 A1
(43) Pub. Date: May 29, 2025

(54) FILTERING LOCATION REPORTS

(71) Applicant: X DEVELOPMENT LLC, Mountain View, CA (US)

(72) Inventors: Bin He, Los Altos, CA (US); Ivan Reznikov, Mountain View, CA (US)

(21) Appl. No.: 18/521,423

(22) Filed: Nov. 28, 2023

(51) Int. Cl. H04W 64/00; G06F 7/14; G06F 16/9537

(52) U.S. Cl. CPC H04W 64/00; G06F 7/14; G06F 16/9537

(57) ABSTRACT

A method for generating a location history for a tracked object includes merging two or more location reports that are adjacent in time and associated with indications that the tracked object has not moved; discarding one of two or more location reports that are adjacent in time and associated with different cell phone tower identifiers; discarding a location report that is greater than a first threshold distance from an immediately preceding location report and from an immediately following location report; and discarding a location report that is greater than a second threshold distance from an immediately preceding location report when both reports are associated with indications that the tracked object has not moved.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tags or labels attached to the physical objects. These tags or labels may be passive or active. The inter-networking capabilities may be leveraged for tracking locations of physical objects. In many situations, objects may be moved at different points in time, such as a package or equipment moved from a truck to a loading dock to a warehouse, or medical equipment that is moved between different rooms (or floors) in a hospital. These types of situations can be very challenging to determine the location of the object with suitable accuracy, including updating of the location as it changes. In addition, systems that use GPS or Wi-Fi may suffer from signal dropout or transmitters going offline, which can reduce the ability to properly identify an object's location.

### BRIEF SUMMARY

According to aspects of the technology, a method includes identifying a set of location reports for a tracked object. Each location report includes at least a location of the tracked object and a timestamp. The method also includes merging two or more location reports of the set of location reports that are adjacent in time and are each associated with a first indication that the tracked object has not moved, and after the merging, filtering the set of location reports to remove one or more outlier locations. Filtering the set of location reports includes: discarding one of two or more location reports of the set of location reports that are adjacent in time and are associated with different cell phone tower identifiers: discarding a first location report of the set of location reports, which is greater than a first threshold distance from a location report of the set of location reports that immediately precedes the first location report and is greater than the first threshold distance from a location report of the set of location reports that immediately follows the first location report; and discarding a second location report of the set of location reports, which is greater than a second threshold distance from an immediately preceding location report of the set of location reports, and wherein the second location report and the immediately preceding location report to the second location report are each associated with a second indication that the tracked object has not moved. The method further includes generating a location history for the tracked object based on the filtered set of location reports.

In some implementations, filtering the filtered set of location reports also includes removing a third location report that is at a vertex of a triangle of three location reports that have an angle at the vertex of less than a threshold angle. For example, the threshold angle may be 20 degrees or more or less.

In some implementations, the first indication is a not-moving flag. In some implementations, the first indication may include accelerometer or gyroscope data.

In some implementations, the two or more location reports that are merged each include locations that are within a third threshold distance of one another.

In some implementations, determining the first threshold distance may be based on accelerometer data for the first location report.

In some implementations, the second indication may be a not-moving flag. In some implementations, the second indication may include accelerometer or gyroscope data.

Some implementations of the method also include sequentially ordering the location reports of the filtered set of location reports by timestamp, so that the sequentially ordered location reports are used to generate the location history.

Some implementations of the method also include displaying the location history with a map to indicate where the tracked object has traveled.

According to other aspects of the technology, a computer includes a non-transitory computer-readable medium that stores computer-executable instructions; and a processor, which is configured by reading the computer-executable instructions from the non-transitory computer-readable medium to perform a method. The method includes identifying a set of location reports for a tracked object, each location report including at least a location of the tracked object and a timestamp. The method also includes merging two or more location reports of the set of location reports that are adjacent in time and are each associated with a first indication that the tracked object has not moved; and, after the merging, filtering the set of location reports to remove one or more outlier location. Filtering the set of location reports may include: discarding one of two or more location reports of the set of location reports that are adjacent in time and are associated with different cell phone tower identifiers: discarding a first location report of the set of location reports, wherein the first location report is greater than a first threshold distance from a location of a location report of the set of location reports that immediately precedes the first location report and is greater than the first threshold distance from a location report of the set of location reports that immediately follows the first location report; and discarding a second location report of the set of location reports having a second location that is greater than a second threshold distance from a location of an immediately preceding location report of the set of location reports to the second location report, and wherein the second location report and the immediately preceding location report to the second location report are each associated with a second indication that the tracked object has not moved. The method also may include generating a location history for the tracked object based on the filtered set of location reports.

In some implementations, the method also may include filtering the filtered set of location reports by removing a third location report that is at a vertex of a triangle of three location reports that have an angle at the vertex of less than a threshold angle.

In some implementations, the two or more location reports that are merged each include locations that are within a third threshold distance of one another.

In some implementations, the first indication is a not-moving flag. In some implementations, the first indication includes accelerometer or gyroscope data.

According to other aspects of the technology, a non-transitory computer-readable medium stores computer-executable instructions for configuring a processor to perform a method. The method includes identifying a set of location reports for a tracked object, each location report including at least a location of the tracked object and a timestamp. The method also includes merging two or more location reports of the set of location reports that are adjacent in time and are each associated with a first indication that the tracked object has not moved; and, after the merging, filtering the set of location reports to remove one or more outlier location. Filtering the set of location reports may include: discarding one of two or more location reports of the set of location reports that are adjacent in time and are associated with different cell phone tower identifiers: discarding a first location report of the set of location reports, wherein the first location report is greater than a first threshold distance from a location of a location report of the set of location reports that immediately precedes the first location report and is greater than the first threshold distance from a location report of the set of location reports that immediately follows the first location report; and discarding a second location report of the set of location reports having a second location that is greater than a second threshold distance from a location of an immediately preceding location report of the set of location reports to the second location report, and wherein the second location report and the immediately preceding location report to the second location report are each associated with a second indication that the tracked object has not moved. The method also may include generating a location history for the tracked object based on the filtered set of location reports.

In some implementations, the method also may include filtering the filtered set of location reports by removing a third location report that is at a vertex of a triangle of three location reports that have an angle at the vertex of less than a threshold angle.

In some implementations, the two or more location reports that are merged each include locations that are within a third threshold distance of one another.

In some implementations, the first indication is a not-moving flag. In some implementations, the first indication includes accelerometer or gyroscope data.

### BRIEF DESCRIPTION OF THE DRAWINGS

FIG. 1A illustrates various examples for localization of objects in accordance with aspects of the technology.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIG. 4A illustrates example scenarios in accordance with aspects of the disclosure.

FIG. 4B illustrates another example of a system having a number of fixed tracking tags positioned along different aisles in a warehouse setting.

FIG. 5 is an example functional diagram of a tracking tag, reader devices, and server computing devices in accordance with aspects of the disclosure.

FIG. 6 shows a map that represents data for a trip (represented by the dashed-line path) including a plurality of unfiltered location reports (represented by darkened circles) each associated with a timestamp (T).

FIG. 7 is a flowchart of a multi-layer outlier location filtering process in accordance with aspects of the disclosure.

FIG. 8 shows the map of FIG. 6 including a set of filtered location reports (represented by darkened circles) that were generated according to the process of FIG. 7.

FIG. 9 depicts a graphical user interface (GUI) that displays a location history on a map along with a log of alerts and trip details in accordance with aspects of the disclosure.

### DETAILED DESCRIPTION

### Overview

The technology relates to systems for tracking objects. Some systems may involve alerting a user when the location of a tracked object is outside of acceptable parameters (e.g., off track or out of place). Such systems may provide information about when tracked objects are currently located, have been in the past, as well as estimated times of arrival (ETAs) for tracked objects at a particular destination. In some instances, these systems may provide location-based alerts. However, in some instances, these systems may suffer from incorrect location histories due to inaccurate location information. This in turn, may result in inaccurate ETAs. For instance, a location signal source may experience an error that momentarily indicates that an object is far from an immediately previous location. In other instances, higher-precision location signal sources may be prone to “jitter” in which the reported locations move rapidly and repeatedly within a small area. Such phenomena can result in a spurious report of the object being out of place, and/or experiencing abnormal acceleration.

To address this, a multi-layer outlier location filtering process may be employed resulting in more accurate and reliable alerts.

For instance, a tracking system may include a tracked object and a server. A tracking device attached to the tracked object, the tracked object, and or an intermediary reader device may send location signals to the server. These location signals may take various forms and may be stored as location reports by the server in a storage system for later retrieval and use as needed.

The location reports may include an identifier for a tracked object, location data as well as timestamp information. In some instances, the location reports may also include not-moving flags or additional sensor data such as accelerometer or gyroscope measurements, etc.

The location data may include any of the cell phone tower location data, GPS location, and/or Wi-Fi location data. In some instances, a GPS location may be determined by the tracking device, tracked object or the intermediary reader device, whereas cell phone tower location and Wi-Fi location may be determined by the server based on data provided in the respective location signals. The server uses the cell phone tower location signal to look up the tracked object's location in a table that is cached at the server. A Wi-Fi location signal may include a list of MAC addresses (and, optionally, signal strengths) for Wi-Fi routers that are near the tracked object. The server sends the Wi-Fi location signal to a GeoLocation API that calculates and returns a location.

The multi-layer outlier location filtering process may start by retrieving all location data for a tracked object. For instance, the server may retrieve from a storage system a set of location reports associated with an identifier of a tracked object.

An initial filtering step of the process may include removal of jittering points by merging two or more location reports of the set of location reports together. Jittering points may include locations that are consecutive in time for the tracked object where the object appears to not be moving.

A second filtering step of the process may include removal of cell phone tower outlier locations of the set of location reports. Cell phone tower outlier locations may include incorrect or less accurate locations based on cell phone tower data. This filtering step may rely on an assumption that Wi-Fi and GPS location data are generally more accurate than locations determined using a cell phone tower identifier.

A third filtering step of the process may include removal of single extreme outlier locations of the set of location reports. Single extreme outlier locations may occur when a sequence of three or more location reports for a tracked object appear to “jump” from a first location a large distance to a second location and then return to a third location near a first location. In such instances, the location report of the second location may be discarded.

A fourth filtering step of the process may identify non-moving outlier locations of the set of location reports. Non-moving outlier locations may occur when two or more location reports that are adjacent in time where the tracked object is reported as not moving but for which the location reports indicate great changes in distance.

A fifth filtering step may filter triangle outlier locations. Triangle outlier locations may include sets of three locations that form a sharp angle of the set of location reports. For instance, if three location reports for a tracked object that are adjacent in time are associated with an angle less than a threshold angle, then the location report corresponding to the vertex of the triangle with the angle less than the threshold may be discarded.

After the initial filtering and one or more of the additional filtering steps have been performed, the remaining location reports for a tracked object may be used for various purposes. For instance, the remaining location reports can be used to generate a location history traveled by the tracked object. This may involve sequentially ordering the remaining location reports by timestamp. In some instances, this may be displayed to a user on a display of a computing device. In addition, or alternatively, the remaining location reports can be used to determine ETAs for the tracked object to reach a particular location. If the ETA is slower than originally expected or faster than originally expected, this may be used to generate and provide alerts to a user. The location reports also may be used to generate geofence-based alerts or alerts in response to the tracked object moving outside of or into a particular geographic area.

Logically, each subsequent filter may be applied to the set/list of locations that have been modified based on the result of the previous step, whether it involves combining jitters into a single location point or removing other outliers.

The features and methodology described herein may improve the technology of object tracking by providing more accurate location histories. This in turn, may provide for more accurate ETAs and more reliable alerts for when a tracked object is off track or out of place.

### Example Systems

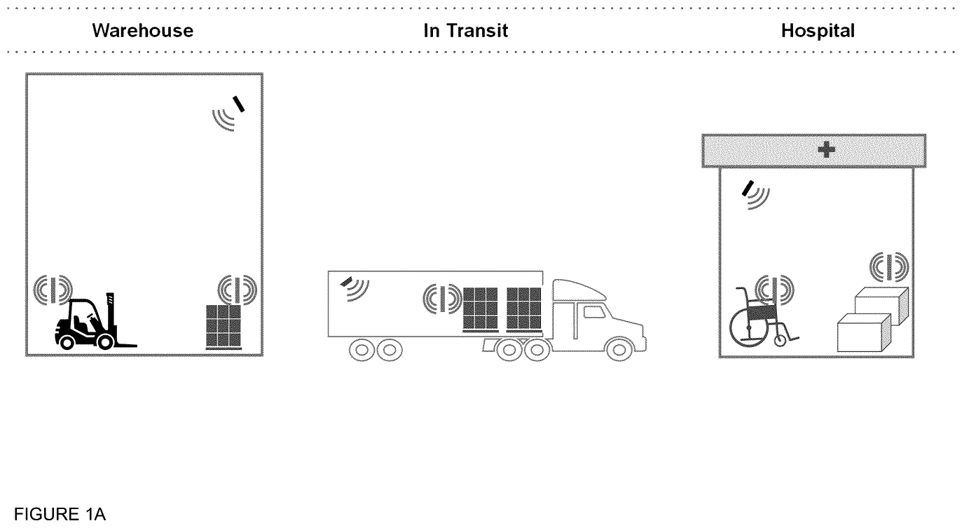

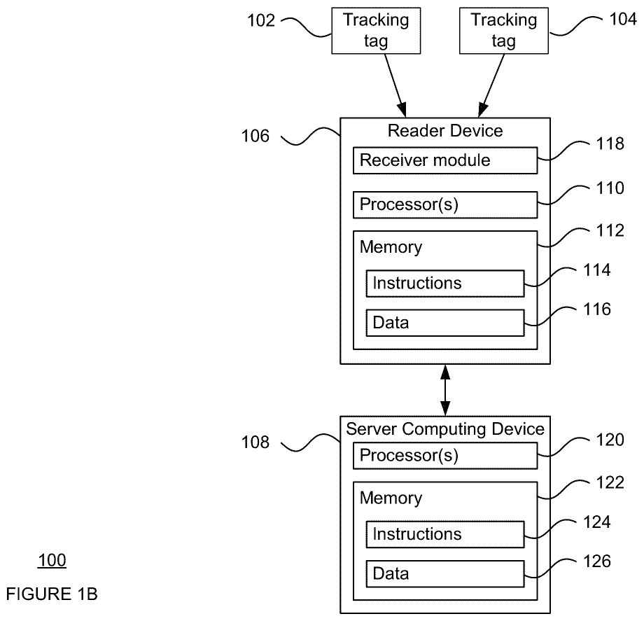

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations-in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where they are presumed to be based on an initial placement, is a valuable piece of information for an office manager, warehouse manager, nurse or orderly to have. Ideally, such people should be able to get the current location of a given object on their client computing device such as a laptop, mobile phone or smartwatch.

FIG. 1B is a functional diagram of a tracking system 100. The tracking system 100 may include a plurality of tracking devices, such as tracking tags 102 and 104, and a reader 106. As discussed further below; one or more server computing devices 108 may also be part of the tracking system 100. A given tracking tag may be placed on or otherwise attached to or inserted into an object to be tracked, such as a package, a piece of equipment, a vehicle, a warehouse section, a room, etc. While tracking tags 102 may be associated with objects such as packages, equipment or vehicles (e.g., a forklift or an autonomous fulfillment robot that can retrieve packages from different locations in a warehouse), tracking tags 104 may be fixed to an aisle in a warehouse or from a specific room in a hospital. Thus, different tracking tags may be used depending upon customer needs. As an example, different customers may have varying accuracy and “liveliness” needs. For instance, one customer may only want to know aisle-level accuracy every day (e.g., before a warehouse closes for the evening), while another customer such as a hospital nurse may need to know which room a piece of equipment is in every hour so that it can be accessed should a patient need such equipment. Each tracking tag 102 or 104 may emit an informational signal, for example a beacon signal, via an antenna, such as using the transmitting device, to communicate data. In this regard, each tracking tag may include an identifier chip (such as for radiofrequency (RF) identification) and/or a transmitting device (such as an RF module configured to transmit beacon signals using a selected frequency band and transmission protocol). In this regard, the beacon signals may simply transmit identifying information in order to enable tracking of objects in the case of tracking tags discussed further below. To facilitate this, each tracking tag may be embedded with a unique identifier, such as a unique MAC address or BLUETOOTH identifier, which may function as a tracking tag identifier. This tracking tag identifier may be assigned to the tracking tag during the manufacturing or provisioning processes (described further below).

The transmitting device may send such information via radio frequency transmission in a selected frequency band, using a standard or proprietary protocol. By way of example, the transmitting device may employ a BLUETOOTH (e.g., a BLUETOOTH Low Energy (BLE)) or 802.11 protocol in the 2.4 GHZ and/or 5 GHz frequency bands. In some examples, each beacon tracking tag and each tracking tag uses the BLUETOOTH or BLE protocol.

In some instances, the tracking tags may include one or more sensors. In such instances, the aforementioned communicated data may be formatted according to the selected protocol and include one or more sensed characteristics of the given tracking tag or its environment. For example, the sensed characteristic may be a temperature, a location, motion, battery conditions, trip conditions, and/or other detectable characteristics of the tracking devices or its environment.

The reader 106 may be a computing device configured to detect the beacon signals emitted by the plurality of tracking tags 102 and 104, then store and/or transmit data related to the tracking tags. While only one reader is shown in FIG. 1B, the system may employ multiple readers. The reader 106 may include one or more processors 110, memory 112 and other components typically present in general purpose computing devices. The reader 106 includes a receive module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion.

The one or more processors 110 may be any conventional processors, such as commercially available CPUs or microcontrollers. Alternatively, the one or more processors may be a dedicated device such as an ASIC or other hardware-based processor, such as a field programmable gate array (FPGA). Although FIG. 1B functionally illustrates the processor(s), memory, and other elements of the reader 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader 106. Indeed, memory may be any non-transitory computer-readable medium that can store computer-executable instructions. Accordingly, references to a processor or computing device will be understood to include references to a collection of processors or computing devices or memories that may or may not operate in parallel.

The memory 112 stores information accessible by the one or more processors 110, including instructions 114 and data 116 that may be executed or otherwise used by the processor(s) 110. The data may include sensed characteristics from any of the tracking tags 102 and/or 104 received by the reader 106. The memory 112 may be of any type capable of storing information accessible by the processor(s), including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by processor(s) 110 in accordance with the instructions 114. For instance, although the claimed subject matter is not limited by any particular data structure, the data may be stored in computing device registers, in a relational database as a table having a plurality of different fields and records, XML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below:

In some implementations, the tracking system 100 may further include a central server, such as one or more server computing devices 108 accessible by the one or more processors 110 of the reader 106. In some implementations, one or more tracking devices in the tracking system 100, such as a tracking tag 104, may be configured to obtain and communicate data directly to the one or more server computing devices 108. The one or more server computing devices 108 may include one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the processor(s) 120. Data 126 and instructions 124 may be the same or similar type as the data 116 and instructions 114, respectively.

After detecting the beacon signals of one or more tracking tags 102 or 104, the reader 106 may transmit the data from the tracking tags to the one or more server computing devices 108 through an existing connection or through a network. Thus, in this case the reader 106 may include a transmitter module (not shown) that is configured for wired or wireless transmission to the server computing device. The data may be received in a series of payloads (e.g., data packets) either continually, at one or more set intervals, or ad hoc whenever the tracking tags transmit. Thus, when there are multiple tracking tags, the data is effectively received as a plurality of separate data streams. A given payload (which may comprise one or more data packets) may include measurements taken at one or more time intervals, each of which may have a corresponding timestamp. In one scenario, the reader 106 may include a transceiver including both a receiver and a transmitter, which is configured to receive beacon signals from the tracking tags 102 and 104 and also to send and receive information with the server computing device 108.

The one or more server computing devices 108 may be configured to track characteristics of the tracking devices for one or more alerts based on a plurality of conditions. The plurality of conditions may include at least one condition for each characteristic, such as a minimum, a maximum, a threshold, a duration, or a geofence. The conditions may be predetermined or set based on user input. For example, a first alert may be set for when (1) a temperature is greater than, e.g., 0° C. to 10° C. for 30 minutes and (2) the tracking device is on a trip, which may indicate overheating of a cooled package or storage compartment. A second alert may be set for when (1) no motion is detected for 10 minutes, (2) 2 of 3 locations are in a geofence, and (3) the tracking device is on a trip, which may indicate that a package is out for delivery. A third alert may be set for when (1) a threshold amount of light is detected from inside a package and (2) the tracking device is on a trip, which may indicate unexpected opening of the package or tampering. A fourth alert may be set for when (1) a threshold amount of light is detected from inside a package and (2) 2 of 3 locations are in a destination geofence, which may indicate opening of the package after delivery or receipt. Many other alert conditions and tracking scenarios are possible, and the above examples are not intended to be limiting.

The tracking system 100 may optionally include an application that may be installed on one or more client computing devices. Using the application, the client computing devices may access the data from the reader 106 and/or the server computing device 108 through a network.

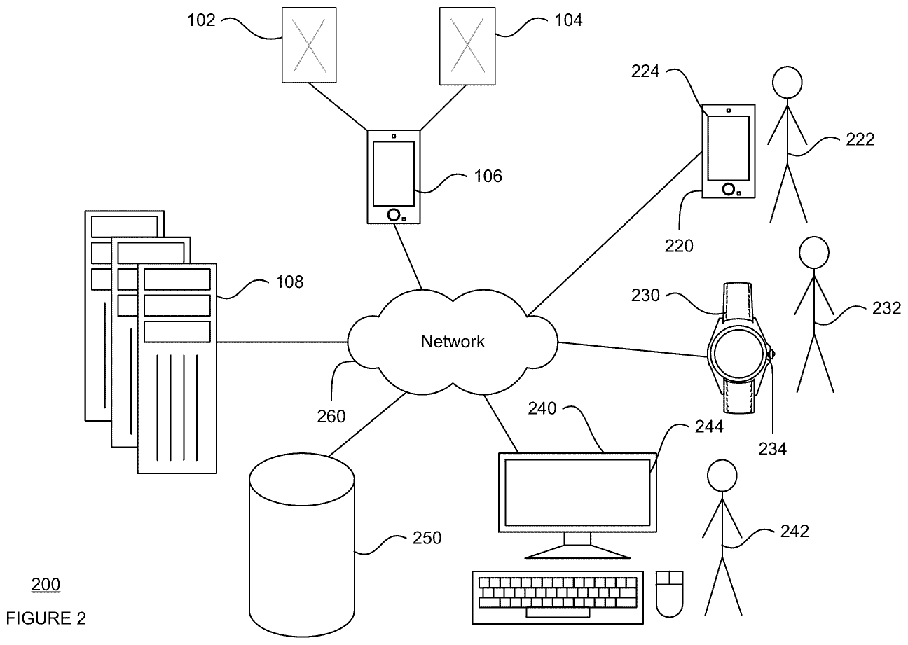

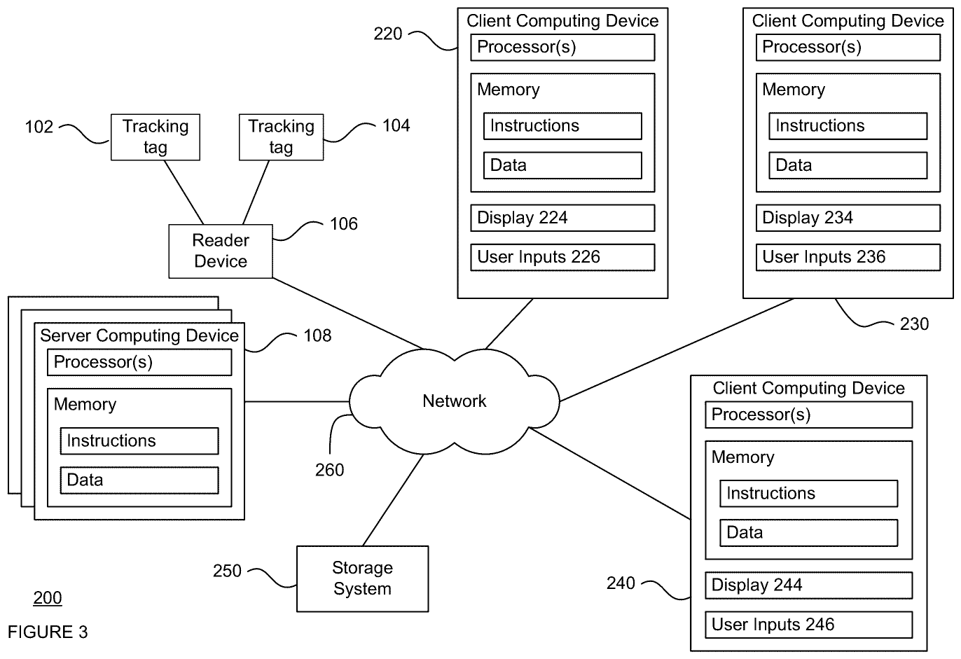

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking tags 102, 104, reader 106, and server computing device 108. Although only a few tags and computing devices are depicted for simplicity, a typical system may include significantly more.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including a one or more processors (e.g., a central processing unit (CPU)), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display, or a netbook that is capable of obtaining information via the Internet or other networks. As an example, the user may input information using a small keyboard, a keypad, microphone, using visual signals (gestures) with a camera or other sensor, or a touch screen.

As with memory 112, storage system 250 can be of any type of computerized storage capable of storing information accessible by the one or more server computing devices 108, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250 may store information about the tracking tags including, for example, location, status (e.g., activated and when), identifiers, last update, sensor data (e.g., temperature measurements), information about the object to which the tracking tag is attached (e.g., manufacturing data), and so on. In this regard, the information may be determined from received beacon signals provided to and updated at the storage system 250 by any of the one or more server computing devices 108 and/or client computing devices 220, 230, 240.

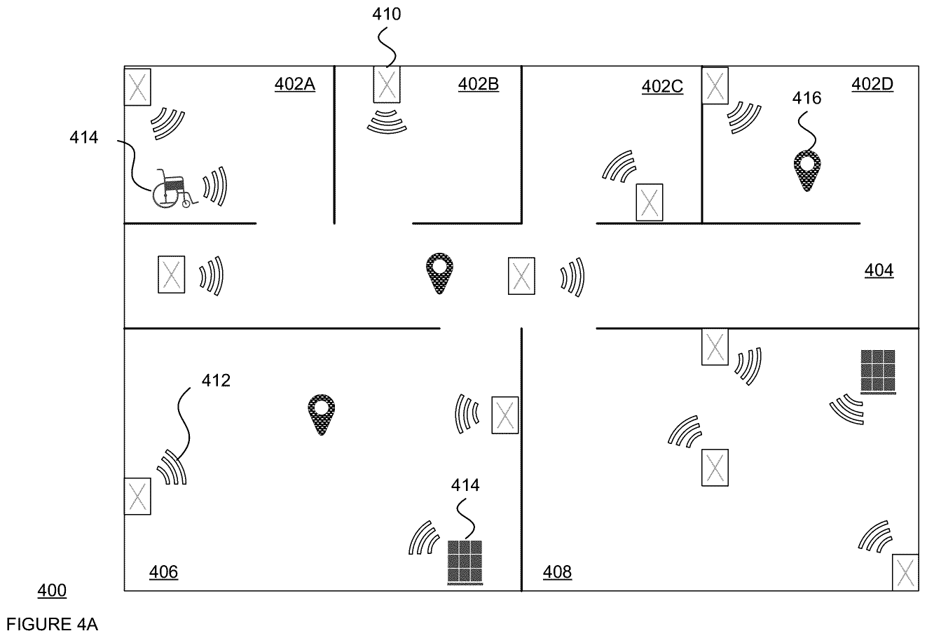

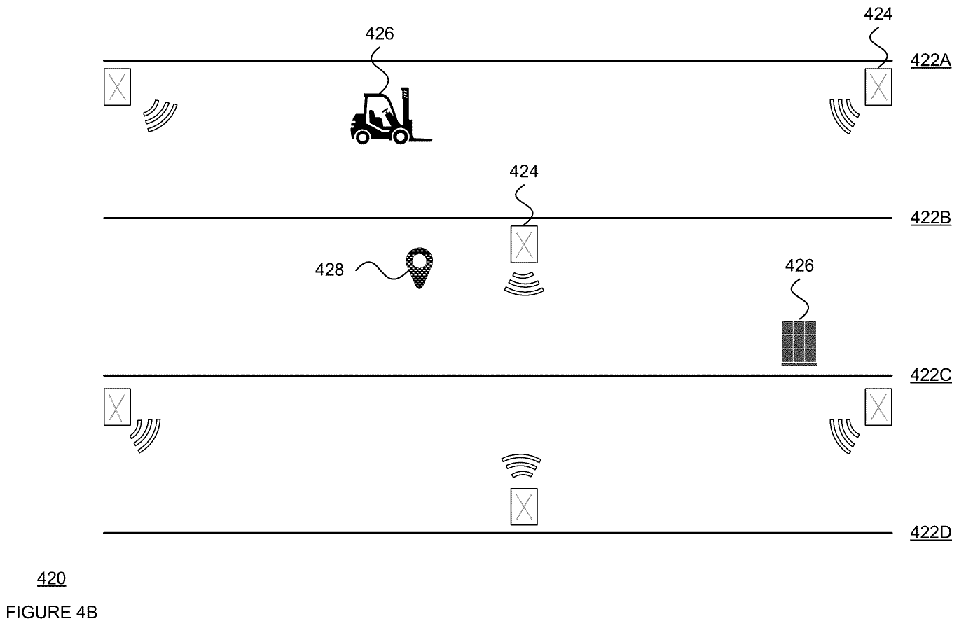

FIG. 4A illustrates one example 400 of a system having a number of tracking tags arranged in various locations of a building (e.g., a hospital). In this example, there may be a number of rooms 402A-402D, such as patient rooms, along one side of a hallway 404. On the opposite side of the hallway 404 there is a storage room 406, such as to house equipment or supplies, as well as another room 408, which may be a meeting room, common area, rehab facility or the like. One or more fixed tracking tags 410 corresponding to the tracking tags 102 or 104 may be located in each room, including the hallway. Each fixed tracking tag 410 is configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking tag 410 that is located on the ceiling, pillar or floor. In some implementations, the tracking tag 410 may be configured to emit beacon signals with information associated with its environment (e.g., temperature, humidity, etc.).

Tracking tags 414 may correspond to tracking tags 102 or 104 when placed on a variety of objects (e.g., a case of supplies as shown in storage room 406 or a wheelchair shown in room 402A). In some instances, the tracking tags may also be configured to emit beacon signals with information associated with the object on which the tracking tag is applied (e.g., temperature, motion information, object details, and/or other detectable characteristics of the tracking device or its environment). Readers 416 may be found at various locations in the building, such as in a patient room, the storage room, the hallway or other location. Note that even if transmitted omnidirectionally, the beacon signals from a given tracking tag may be attenuated in a non-uniform manner due to the presence of walls, furniture, floors/ceilings, equipment, etc.

FIG. 4B illustrates another example 420 of a system having a number of fixed tracking tags positioned along different aisles in a warehouse setting. In this example, there are a number of aisles 422A-422D, although there may be more (or fewer) aisles, and the aisles may be arranged in other configurations than what is shown. Here, fixed tracking tags 424 are located at different places for the aisles, such as along aisle end caps, along the ceiling (or floor), on shelves, storage lockers, cabinets or other places along the aisle, etc. Similar to FIG. 4A, fixed tracking tags 426 are placed on or otherwise associated with different objects, such as a pallet of equipment or a forklift that retrieves items from their locations in the warehouse. As above, the fixed tracking tags are configured to transmit beacon signals that are detectable by one or more readers 428.

In order to determine the location of a given tracking tag, the system may use beacon signals of one or more tracking tags. The storage system 250 may store location reports that may be generated based on the beacon or other signals. A location report may include location data and a timestamp. As an example, a “timestamp” may include a time when location data was generated, received, or recorded. Location data may include any of GPS location data, cell phone tower location data, and/or Wi-Fi location data. For example, a location report may include a GPS location that is encoded in a beacon signal. As another example, a location report may include a location that is generated by one or more reader devices based on signal strength and/or azimuth of the beacon signal at each of the reader devices. As another example, a location report may include a location of a reader device that detects a beacon signal.

In some instances, a GPS location may be determined by the tracking device, tracked object, or the intermediary reader device, whereas cell phone tower location and Wi-Fi location may be determined by the server based on the location data provided in the respective beacon signals. For example, the server may receive a beacon signal that encodes a cell phone tower identifier and then generate a location report by looking up the tracked object's location in a table that is cached at the server. As another example, a beacon signal may encode Wi-Fi location, which includes a list of MAC addresses (and, optionally, signal strengths) for Wi-Fi routers that are near the tracked object. The server may send the Wi-Fi location data from the beacon signal to a geographic location API that calculates and returns a location with which the server can generate a location report. In some instances, the location data also may include not-moving flags or additional sensor data such as accelerometer or gyroscope measurements, etc.

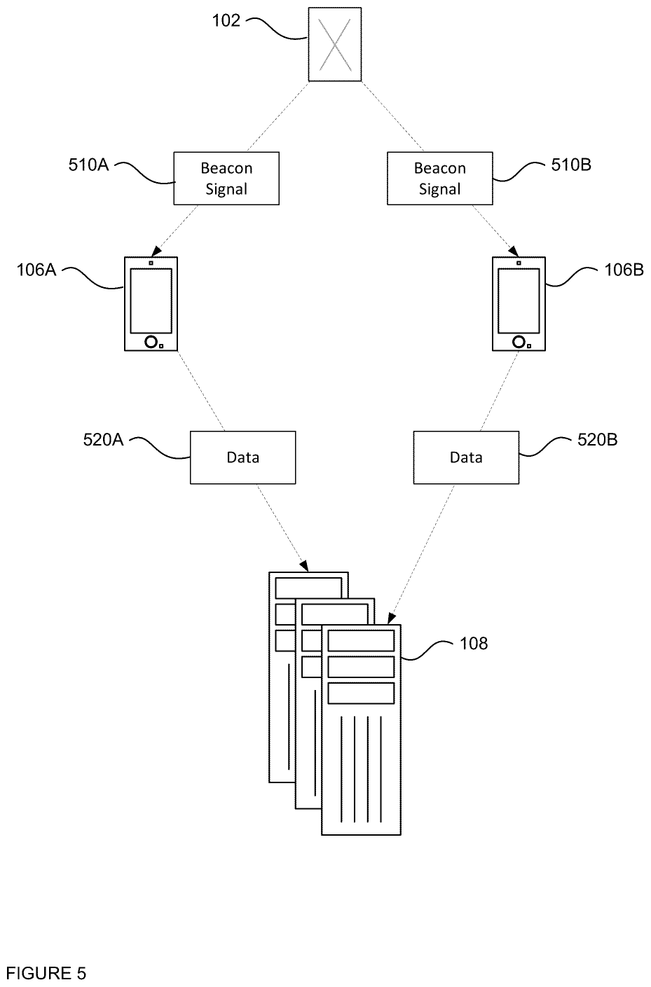

For example, referring to FIG. 5, tracking tag 102 may transmit beacon signals 510A, 510B which may be received by reader devices 106A, 106B (which may be configured the same or similarly to reader device 106). Each reader device in turn may transmit data 520A, 520B to the one or more server computing devices 108. As noted above, this data may provide information about the beacon signals 510A, 510B received from the tracking tag 102. Such information may include tracking tag identifiers, state information (e.g., whether or not the tracking tag has moved or is moving, temperature measurements, whether one or more thresholds have been met, etc.), etc. Thus, in this example, each of the reader devices 106A, 106B is within range of the tracking tag 102.

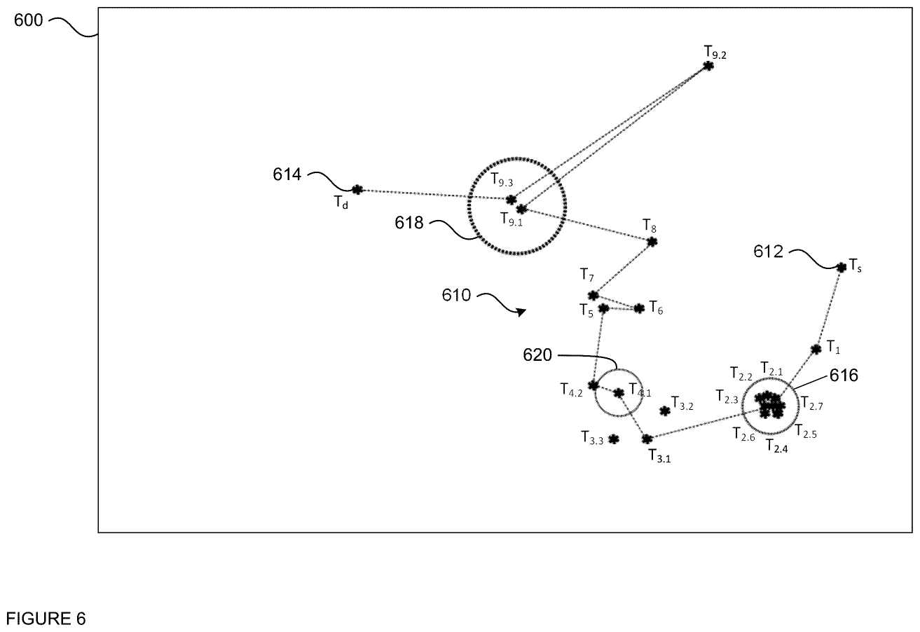

FIG. 6 shows a map 600 that represents data for a sequence (represented by the dashed-line path) of location reports 610 (represented by darkened circles). Each location report is associated with a timestamp (T). The location reports and timestamps are produced by a first tracking tag, which may be configured the same as or similarly to tracking tags 102, 104. The first tracking tag is attached to a first object as that object moves between two locations: starting location 612 (associated with starting timestamp Ts) and destination location 614 (associated with destination timestamp Td). In this example, timestamps Tₛ, T₁, T_{2.1}, T_{2.2}, T_{2.3}, T_{2.4}, T_{2.5}, T_{2.6}, T_{2.7}, T_{3.1}, T_{3.2}, T_{3.3}, T_{4.1}, T_{4.2}, T₅, T₆, T₇, T₈, T_{9.1}, T_{9.2}, T_{9.3}, Ta are generated sequentially and may be stored in the same sequence or in any order.

### Example Methods

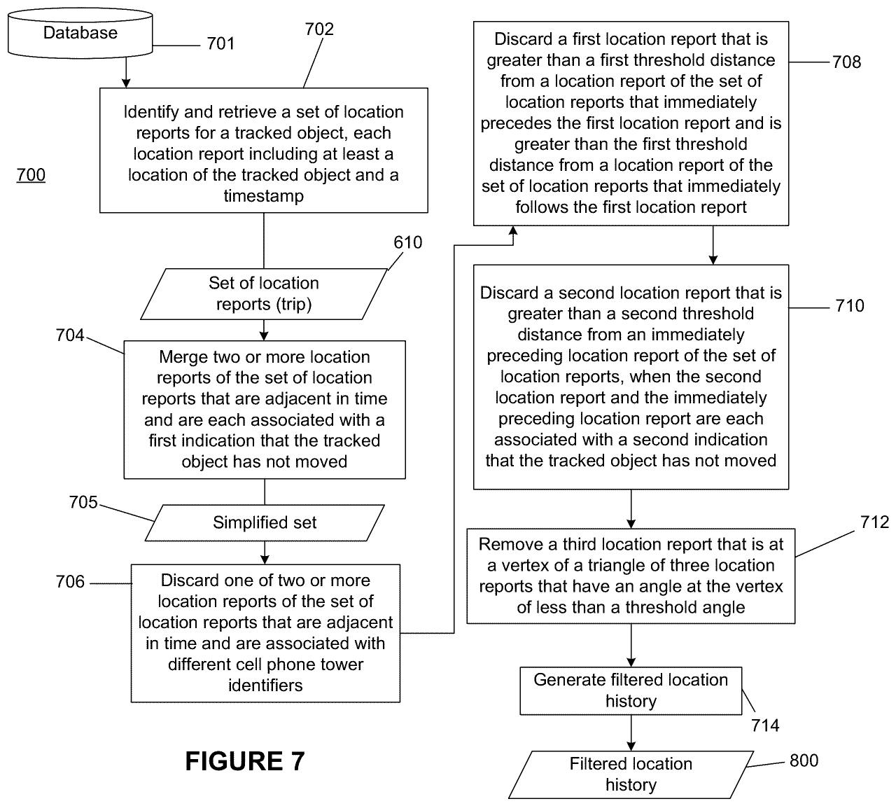

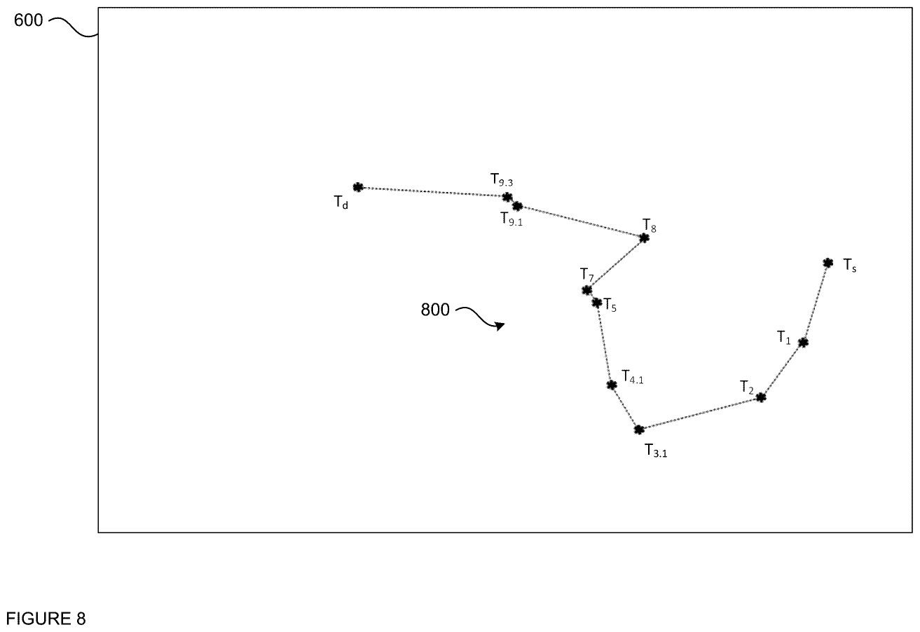

FIG. 7 is an example flowchart of a multi-layer outlier location filtering process 700, which may be performed by one or more processors of one or more computing devices, such as the processors of the one or more server computing devices 108. In this example, the process 700 may produce a filtered location history 800 (as shown in FIG. 8) for a tracked object. While FIG. 7 shows blocks in a particular order, the order may be varied and multiple operations may be performed simultaneously. Also, operations may be added or omitted. The process 700 may start at block 702 by identifying and retrieving a set of location reports for a tracked object Each location report includes at least a location of the tracked object and a timestamp. For instance, the server computing devices 108 may access and retrieve from a storage system or database 701 a set of location reports that correspond to the trip 610 that is associated with an identifier of a tracked object. These location reports may be sequentially ordered by timestamp.

An initial filtering step of the process may include removal of jittering points by merging two or more location reports of the set of location reports that are adjacent in time and are each associated with a first indication that the tracked object has not moved. Jittering points may include locations that are consecutive in time for the tracked object where the object appears to not be moving. For instance, as shown in block 704, two or more location reports of the set of location reports that are adjacent in time and are each associated with a first indication that the tracked object has not moved are merged. For instance, if two or more location reports for a tracked object that are adjacent in time are associated with a not-moving flag or sensor data (e.g., accelerometer or gyroscope data) which indicates that the tracked object has not moved, these location reports may be merged together into a single location report. In some aspects of the disclosure, points that are within a threshold distance of one another may be merged, while points that are further apart may not be merged. As an example, the threshold distance may be a hard coded threshold (e.g., 100 meters). In some instances, the threshold distance may be defined by an accuracy range of each of the location reports. For example, for two consecutive points that are marked as not-moving (e.g., accelerometer based) the threshold distance may be accuracy of the first point plus an accuracy of the second point, where the accuracies are obtained from a GeoLocation API.

Returning to FIG. 6, consider the location reports in FIG. 6 that are marked by timestamps T_{2.1} through T_{2.7}. In this example, the server computing devices 108 may process these location reports and determine that each of these timestamps are consecutive in time. Optionally, the location reports also may be associated with a not-moving flag or sensor data (e.g., accelerometer or gyroscope data) which indicates that the tracked object has not moved. In some instances, the locations of the location reports may be determined to be within a threshold distance 616 from each other. The threshold distance 616 may be defined by a sum of the accuracy ranges of each of the location reports when the tracked object is stationary, or may be a hard coded value when the tracked object is in motion. Thus, based on these determinations, the server computing devices 108 may merge location reports with timestamps T_{2.1} through T_{2.7} together. This merging may result in a single location report with timestamp T₂, as shown in FIG. 8. In some aspects of the disclosure, T₂ may be an averaged time of the timestamps T_{2.1} through T_{2.7} and the location of T₂ may be a centroid of the location reports with timestamps T_{2.1} through T_{2.7}.

Another filtering step of the process may include removal of cell phone tower outlier locations of the set of location reports. Cell phone tower outlier locations may include incorrect or less accurate locations based on cell phone tower data. Returning to FIG. 7, at block 706, one of two or more location reports of the set of location reports that are adjacent in time and are associated with different cell phone tower identifiers are discarded. For instance, there may be a sequence of location reports including GPS location, and/or Wi-Fi location data at the beginning and end of the sequence, with one or more location reports including cell phone tower location data in the middle of the sequence (e.g., between the location reports at the beginning and end of the sequence). One or more of the location reports with the cell phone tower location data may then be discarded. In some instances, any of the location reports including cell phone tower location data may be identified as an outlier and discarded. This filtering step may rely on an assumption that Wi-Fi and GPS location data are generally more accurate than locations determined using a cell phone tower identifier.

As an example, the location reports with timestamps T_{3.1} and T_{4.1} in FIG. 6 may represent a sequence of location reports. In this regard, the sequence of location reports includes GPS location, and/or Wi-Fi location data at the beginning of the sequence (at timestamp T_{3.1}) and at the end of the sequence (T_{4.1}). Between the timestamps of T_{3.1} and T_{4.1}, are a plurality of location reports with timestamps T_{3.2} and T_{3.3}. In this example, each of the location reports with timestamps T_{3.2} and T_{3.3} include cell phone tower location data. Accordingly, the server computing devices 108 may filter or discard the location reports at timestamps T_{3.2} and T_{3.3} with the cell phone tower location data. As a result of filtering the cell phone tower outlier locations, the filtered location history 800 (as shown in FIG. 8) includes the location reports with timestamps T_{3.1} and T_{4.1} but does not include the location reports with timestamps T_{3.2} and T_{3.3}.

Another filtering step of the process may include removal of single extreme outlier locations of the set of location reports. Single extreme outlier locations may occur when a sequence of three or more location reports for a tracked object include locations which appear to “jump” from a first location a large distance to a second location and then return to a third location near the first location. Returning to FIG. 7, at block 708, a first location report is discarded when the first location report is greater than a first threshold distance from a location report of the set of location reports that immediately precedes the first location report and also is greater than the first threshold distance from a location report of the set of location reports that immediately follows the first location report.

The threshold distance may be based on a time between consecutive location reports combined with a maximum allowed speed. For example, if a maximum allowed speed is 100 miles per hour, and there are three location reports (Report 1 at 11 am in New York, NY; Report 2 at 11:15 am in San Francisco, CA; Report 3 at 11:30 am in New York, NY), then multiplying the maximum allowed speed by the times between the location reports will indicate that the distance from Report 1 to Report 2 exceeds the threshold distance and that the distance from Report 2 to Report 3 exceeds the threshold distance. Accordingly, at least Report 2 would be identified as a single extreme outlier and discarded.

A time limitation may be used by the server computing devices 108 to identify the three or more location reports. This time limitation may include that the three or more location reports occur within a predetermined period of time such as less than 30 seconds to less than 4 hours. In addition, a threshold distance may be applied such that a location report is discarded if it is greater than the threshold distance from immediately preceding and immediately following location reports. In such instances, the location report may be identified as an outlier and discarded.

As an example, the location reports marked with the timestamps T_{9.1}. T_{9.2} and T_{9.3} in FIG. 6 represent a sequence of timestamps that meet a time limitation. In this example, the time limitation may be that the timestamps of these location reports occur within a predetermined period of time, such as less than 30 seconds to less than 4 hours. In this sequence, the location report of timestamp T_{9.2} is more than a threshold distance 618 away from each the location reports of timestamps T_{9.1} and T_{9.3}. In this example, a first location of the location report at timestamp T_{9.2} appears to “jump” from the first location to a second location of the location report of timestamp T_{9.1} and then to a third location of the location report of timestamp T_{9.3}. In this example, the first and third locations are near one another and the second location is greater than the first threshold distance from the first location. In addition, the second location also is greater than a first threshold distance 618 from the third location. Therefore, the third location of the location report of timestamp T_{9.2} may be identified by the server computing devices 108 as a single extreme outlier and would be discarded. As a result, in FIG. 8 the filtered location history 800 would include the location reports with timestamps T_{9.1} and T_{9.3} but not the location report of timestamp T_{9.2}.

Another filtering step of the process may identify non-moving outlier locations of the set of location reports. Non-moving outlier locations may occur when the tracked object is reported as not moving for two or more location reports, which are adjacent in time and indicate changes in distance that are greater than a threshold distance. Returning to FIG. 7, at block 710 a second location report is discarded when the second location report is greater than a second threshold distance from an immediately preceding location report of the set of location reports, and when the second location report and the immediately preceding location report to the second location report are each associated with a second indication that the tracked object has not moved. For instance, if two or more location reports for a tracked object that are adjacent in time are associated with a not-moving flag or sensor data (e.g., gyroscope or accelerometer data) which indicates that the tracked object has not moved, one or both of the location reports may be discarded. In some instances, if the speed required to move between the two consecutive locations is greater than a threshold speed value, then the second location may be identified as an outlier and discarded. In this regard, this filtering step can eliminate multiple “impossible” location reports at once.

As an example, in FIG. 6, the two location reports with timestamps T_{4.1} and T_{4.2} are adjacent in time. The server computing devices 108 may determine that each of these location reports includes a not-moving flag or sensor data (e.g., gyroscope or accelerometer data) which indicates that the tracked object has not moved. The server computing devices 108 may also determine that the location report with timestamp T_{4.2} is greater than a second threshold distance 620 from the location report with timestamp T_{4.1}. Accordingly, the server computing devices 108 identifies the location report with timestamp T_{4.2} as a not-moving outlier and discards the location report with timestamp T_{4.2}, so that the filtered location history 800 (shown in FIG. 8) includes the location report with timestamp T_{4.1} but not the location report with timestamp T_{4.2}.

Another filtering step may filter triangle outlier locations. Triangle outlier locations may include sets of three locations of sequential location reports that form a sharp angle. Returning to FIG. 7, at block 712, a third location report is removed when the third location report is at a vertex of a triangle of three location reports that have an angle at the vertex of less than a threshold angle. For instance, if three location reports for a tracked object that are adjacent in time are associated with an angle less than a threshold angle of 20 degrees or more or less, then the location report corresponding to the vertex of the triangle with the angle less than the threshold may be discarded.

As an example, referring again to FIG. 6, the server computing devices 108 use the sequence of three location reports with timestamps T₅, T₆, T₇ to form a triangle having three vertices each with a respective angle. The server computing devices 108 may analyze the angle of each vertex of the triangle to determine whether one of the vertices forms an angle of less than a threshold angle. In this example, the threshold angle may be 20 degrees, and the angle at the vertex of the triangle corresponding to the location report of timestamp T₆ may be less than the threshold angle. Accordingly, the server computing devices 108 may discard the location report with timestamp T₆. As such, in the filtered location history 800 (shown in FIG. 8), the location reports with timestamps T₅ and T₇ would be included but the location report with timestamp T₆ would not be included.

As noted above, the steps of blocks 706 through 712 may be performed in any order. For example, after the initial filtering and one or more of the additional filtering steps have been performed, at block 714 the server computing devices 108 use the remaining location reports for a tracked object to generate the filtered location history 800. Generating the filtered location history may involve sequentially ordering the remaining location reports by timestamp.

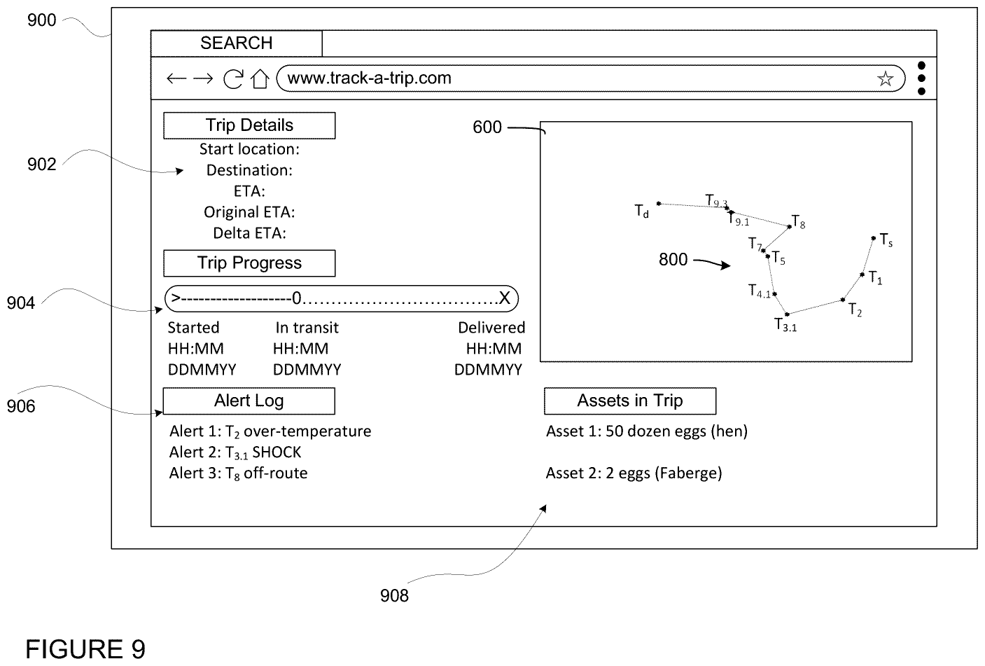

The filtered location history 800 may be used for various purposes. For instance, the server computing devices 108 may use the filtered location history 800 to generate a location history (e.g., a trip) that has been traveled by the tracked object. Any of the client computing devices 220, 230, 240 may display the trip to a user via a graphical user interface (GUI) 900 as shown, for example, in FIG. 9. The display of the trip may include multiple location reports displayed with their timestamps, along with a line connecting the location reports. The display of the trip also may include trip details 902, a progress bar 904, trip alerts 906, and a list of assets 908, as further discussed below.

The GUI 900 displays the filtered location history 800 on the map 600. The server computing devices 108 may use the filtered location histories 800 of one or more tracked objects or assets to generate trip details 902, which may be displayed by the GUI 900. Trip details 902 may include, for example, start location, destination, current estimated time of arrival (ETA), original ETA, and a change or delta ETA over the course of the trip. Current ETA may be based on, for example, distance from a location of a most recent location report to the destination, timestamp of the most recent location report, and expected speed between the location of the most recent location report and the destination.

The server computing devices 108 also may use the filtered location history 800 to generate a trip progress bar 904, which may show start time and date, current (“in transit”) time and date, and an actual or expected delivered time and date (e.g., an ETA as discussed above). Thus, the filtered location history 800 can be used to determine an ETA for the tracked object to reach a particular location, as illustrated in the trip details 902 and as graphically depicted by the trip progress bar 904. If the ETA is slower than originally expected or faster than originally expected, this may be used to generate and provide alerts to a user. The location reports also may be used to generate geofence-based alerts or alerts in response to the tracked object moving outside of or into a particular geographic area.

The server computing devices 108 also may use the filtered location history 800 and other trip data, e.g., temperature or other sensor measurements included in the location reports, to generate an alert log 906. The alert log 906 may include, for example, a list of conditions that were experienced by assets on the trip, such as over-temperature (Alert 1), shock (Alert 2), off-route (Alert 3), etc.

The server computing devices 108 also may correlate filtered location history 800 from a plurality of assets to generate a list of assets 908 that are involved in a common trip. For example, if a set of assets share location reports with similar timestamps and locations, then the server computing devices 108 may add all of the set of assets to the list of assets 908. For showing a trip/asset view (user interface that displays all information about a given trip or asset), the server computing devices find all devices that are assigned to the given trip/asset and gets all location reports from those devices. For showing a device view (user interface that displays all information about a given device during a given time), the server computing devices find all assets and trips that have been assigned to the device during the given time.

As mentioned, trip data can be used to provide alerts for an object being off-route, arriving at a wrong destination, or otherwise deviating from plan. However, erroneous location reports can produce spurious alerts. For example, in FIG. 6, the location report marked with timestamp T_{9.2} could produce an off-track alert. As another example, the location reports marked with timestamps T_{2.1}-T_{2.7} could produce an alert for excessive acceleration. Using the filtered location history 800 as the basis for alerts may mitigate the problem of false alerts. For example, merging jittering points and/or discarding single extreme outliers and/or not-moving outliers may mitigate a problem of false alerts for “shock” (excessive acceleration). Discarding cell phone tower location data outliers, single extreme outliers, and/or triangle vertex outliers may mitigate a problem of false alerts for a tracked object going off-route. Thus, a system that makes use of the method 700 for filtering location history may avoid unnecessarily alerting a user to spurious problems. Avoiding false alerts enhances user satisfaction with a tracking system and reduces computational load to implement the tracking system.

For enhanced debugging and logging of the filtering process, outliers are collected in separate sets according to the criteria that mark them as outliers. This can help understand, during the creation of these filters, whether outliers belong to multiple sets, which, in turn, can help avoid unnecessary steps that repeatedly remove the same location points.

Logically, each subsequent filter is applied to the set/list of locations that have been modified based on the result of the previous step, whether it involves combining jitters into a single location point or removing other outliers.

The features and methodology described herein may improve the technology of object tracking by providing more accurate location histories. This in turn, may provide for more accurate ETAs and more reliable alerts for when a tracked object is off track or out of place.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples: rather, the examples are intended to illustrate only some of many possible embodiments. Further, the same reference numbers in different drawings can identify the same or similar elements.

1. A method comprising:
identifying a set of location reports for a tracked object, each location report including at least a location of the tracked object and a timestamp;
merging two or more location reports of the set of location reports that are adjacent in time and are each associated with a first indication that the tracked object has not moved;
after the merging, filtering the set of location reports to remove one or more outlier location by:
discarding one of two or more location reports of the set of location reports that are adjacent in time and are associated with different cell phone tower identifiers;
discarding a first location report of the set of location reports, wherein the first location report is greater than a first threshold distance from a location report of the set of location reports that immediately precedes the first location report and is greater than the first threshold distance from a location report of the set of location reports that immediately follows the first location report; and
discarding a second location report of the set of location reports, wherein the second location report is greater than a second threshold distance from an immediately preceding location report of the set of location reports, and wherein the second location report and the immediately preceding location report to the second location report are each associated with a second indication that the tracked object has not moved; and
generating a location history for the tracked object based on the filtered set of location reports.

2. The method of claim 1, further comprising, filtering the filtered set of location reports by removing a third location report that is at a vertex of a triangle of three location reports that have an angle at the vertex of less than a threshold angle.

3. The method of claim 2, wherein the threshold angle is 20 degrees.

4. The method of claim 1, wherein the first indication is a not-moving flag.

5. The method of claim 1, wherein the first indication includes accelerometer or gyroscope data.

6. The method of claim 1, wherein the two or more location reports that are merged each include locations that are within a third threshold distance of one another.

7. The method of claim 1, further comprising, determining the first threshold distance based on accelerometer data for the first location report.

8. The method of claim 1, wherein the second indication is a not-moving flag.

9. The method of claim 1, wherein the second indication includes accelerometer or gyroscope data.

10. The method of claim 1, further comprising, sequentially ordering the location reports of the filtered set of location reports by timestamp, and wherein the sequentially ordered location reports are used to generate the location history.

11. The method of claim 1, further comprising, displaying the location history with a map to indicate where the tracked object has traveled.

12. A computer comprising:
a non-transitory computer-readable medium that stores computer-executable instructions; and
a processor, which is configured by reading the computer-executable instructions from the non-transitory computer-readable medium to perform a method comprising:
identifying a set of location reports for a tracked object, each location report including at least a location of the tracked object and a timestamp;
merging two or more location reports of the set of location reports that are adjacent in time and are each associated with a first indication that the tracked object has not moved;
after the merging, filtering the set of location reports to remove one or more outlier location by:
discarding one of two or more location reports of the set of location reports that are adjacent in time and are associated with different cell phone tower identifiers;
discarding a first location report of the set of location reports, wherein the first location report is greater than a first threshold distance from a location of a location report of the set of location reports that immediately precedes the first location report and is greater than the first threshold distance from a location report of the set of location reports that immediately follows the first location report; and
discarding a second location report of the set of location reports having a second location that is greater than a second threshold distance from a location of an immediately preceding location report of the set of location reports to the second location report, and wherein the second location report and the immediately preceding location report to the second location report are each associated with a second indication that the tracked object has not moved; and
generating a location history for the tracked object based on the filtered set of location reports.

13. The computer of claim 12, wherein the method further comprises filtering the filtered set of location reports by removing a third location report that is at a vertex of a triangle of three location reports that have an angle at the vertex of less than a threshold angle.

14. The computer of claim 12, wherein the two or more location reports that are merged each include locations that are within a third threshold distance of one another.

15. The computer of claim 12, wherein the first indication is a not-moving flag.

16. The computer of claim 12, wherein the first indication includes accelerometer or gyroscope data.

17. A non-transitory computer-readable medium that stores computer-executable instructions for configuring a processor to perform a method comprising:
Identifying a set of location reports for a tracked object, each location report including at least a location of the tracked object and a timestamp;
merging two or more location reports of the set of location reports that are adjacent in time and are each associated with a first indication that the tracked object has not moved;
after the merging, filtering the set of location reports to remove one or more outlier location by:
discarding one of two or more location reports of the set of location reports that are adjacent in time and are associated with different cell phone tower identifiers;
discarding a first location report of the set of location reports, wherein the first location report is greater than a first threshold distance from a location of a location report of the set of location reports that immediately precedes the first location report and is greater than the first threshold distance from a location report of the set of location reports that immediately follows the first location report; and
discarding a second location report of the set of location reports having a second location that is greater than a second threshold distance from a location of an immediately preceding location report of the set of location reports to the second location report, and wherein the second location report and the immediately preceding location report to the second location report are each associated with a second indication that the tracked object has not moved; and
generating a location history for the tracked object based on the filtered set of location reports.

18. The non-transitory computer-readable medium of claim 17, wherein the method further comprises filtering the filtered set of location reports by removing a third location report that is at a vertex of a triangle of three location reports that have an angle at the vertex of less than a threshold angle.

19. The non-transitory computer-readable medium of claim 17, wherein the two or more location reports that are merged each include locations that are within a third threshold distance of one another.

20. The non-transitory computer-readable medium of claim 17, wherein the first indication is a not-moving flag.
